(19) United States
(12) Patent Application Publication
(10) Pub. No.: US 2025/0181390 A1
(43) Pub. Date: Jun. 5, 2025

(54) SCALABLE PAIRINGS OF CHIPLETS OF A DISPLAY CONTROL CIRCUIT

(71) Applicants: Advanced Micro Devices, Inc., Santa Clara, CA (US); ATI Technologies ULC, Markham (CA)

(72) Inventors: Gia Tung Phan, Markham (CA); Andrew S. Pomianowski, Bellevue, WA (US); Dennis Kin-Wah Au, Markham (CA)

(21) Appl. No.: 18/530,020

(22) Filed: Dec. 5, 2023

(51) Int. Cl. G05B 19/4099

(52) U.S. Cl. CPC G06F 9/5005; G05B 2219/45031

(57) ABSTRACT

An apparatus and method for efficiently managing performance among replicated functional blocks of an integrated circuit despite different circuit behavior amongst the functional blocks due to manufacturing variations. An integrated circuit includes one or more semiconductor dies that include a first set of replicated functional blocks, each capable of processing a first portion of one or more tasks. One or more other semiconductor dies include a second set of replicated functional blocks, each capable of processing a second portion of the one or more tasks. A control circuit receives a request to process tasks that requires higher performance. The control circuit identifies, on a higher performance semiconductor die, a first functional block of the first set of functional blocks, and assigns, using an identifier of the higher performance semiconductor die, a pairing of the first functional block and a second functional block of the second set of functional blocks.

### BACKGROUND

### Description of the Relevant Art

Generally speaking, semiconductor fabrication includes multiple complex steps to produce multiple semiconductor dies on a wafer with each semiconductor die providing the same functionality. These steps can cause one or more semiconductor dies on the wafer to have different circuit behavior than other semiconductor dies on the same wafer or another wafer despite each of the semiconductor dies providing the same functionality. These differences in behavior result from manufacturing variations across semiconductor dies that inadvertently cause different widths of metal gates and metal traces, different doping levels of source and drain regions, different thicknesses of insulating oxide layers, different thicknesses of metal layers, and so on. These manufacturing variations also affect the threshold voltages of transistors. When the semiconductor package utilizes multiple copies of a same semiconductor die and even when the multiple copies receive a same workload, the behavior of the resulting semiconductor chip can vary depending on which bins the semiconductor dies were selected to be placed in the semiconductor chip.

In view of the above, efficient methods and apparatuses for managing performance among replicated functional blocks of an integrated circuit despite different circuit behavior amongst the functional blocks due to manufacturing variations are desired.

### BRIEF DESCRIPTION OF THE DRAWINGS

FIG. 1 is a generalized block diagram of an integrated circuit that manages performance and power consumption among replicated functional blocks, such as semiconductor dies, of an integrated circuit despite different circuit behavior of the functional blocks due to manufacturing variations.

FIG. 2 is a generalized block diagram of an integrated circuit that manages performance and power consumption among replicated functional blocks, such as semiconductor dies, of an integrated circuit despite different circuit behavior of the functional blocks due to manufacturing variations.

FIG. 3 is a generalized block diagram of an integrated circuit that manages performance and power consumption among replicated functional blocks, such as semiconductor dies, of an integrated circuit despite different circuit behavior of the functional blocks due to manufacturing variations.

FIG. 4 is a generalized block diagram of an integrated circuit that manages performance and power consumption among replicated functional blocks, such as semiconductor dies, of an integrated circuit despite different circuit behavior of the functional blocks due to manufacturing variations.

FIG. 5 is a generalized block diagram of a configuration control circuit that manages performance and power consumption among replicated functional blocks, such as semiconductor dies, of an integrated circuit despite different circuit behavior of the functional blocks due to manufacturing variations.

FIG. 6 is a generalized diagram of a method for efficiently managing performance and power consumption among replicated functional blocks, such as semiconductor dies, of an integrated circuit despite different circuit behavior of the functional blocks due to manufacturing variations.

FIG. 7 is a generalized diagram of a method for efficiently managing performance and power consumption among replicated functional blocks, such as semiconductor dies, of an integrated circuit despite different circuit behavior of the functional blocks due to manufacturing variations.

FIG. 8 is a generalized diagram of a method for efficiently managing performance and power consumption among replicated functional blocks, such as semiconductor dies, of an integrated circuit despite different circuit behavior of the functional blocks due to manufacturing variations.

FIG. 9 is a generalized block diagram of an integrated circuit that manages performance and power consumption among replicated functional blocks, such as semiconductor dies, of an integrated circuit despite different circuit behavior of the functional blocks due to manufacturing variations.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods efficiently managing performance among replicated functional blocks of an integrated circuit despite different circuit behavior amongst the functional blocks due to manufacturing variations are contemplated. In various implementations, an integrated circuit includes multiple semiconductor dies. One or more of the semiconductor dies includes a first set of replicated functional blocks, each representing an instantiated copy of integrated circuitry that processes a first portion of one or more tasks. One or more other semiconductor dies includes a second set of replicated functional blocks, each representing an instantiated copy of integrated circuitry that processes a second portion of the one or more tasks. In some implementations, each of the first set of functional blocks is a frontend circuit that processes rendered video data, and each of the second set of functional blocks is a backend circuit that processes data generated by the first functional block. Additionally, each of the second set of functional blocks is connected to an endpoint device such as a display device.

A microcontroller, or another processing circuit, includes a configuration control circuit that determines a performance level of each of the multiple semiconductor dies. In an implementation, during a bootup operation, the configuration control circuit reads a table, such as a fuse array or other data storage elements, in each of the multiple semiconductor dies that identifies a performance level of a corresponding semiconductor die. The configuration control circuit receives a request that requires a higher performance functional block of the first set of functional blocks. In an implementation, the request includes an indication that a particular display device is to use a higher refresh rate. The configuration control circuit identifies, on a higher performance semiconductor die of the multiple semiconductor dies, an available first functional block of the first set of functional blocks. The configuration control circuit assigns, using an identifier of the higher performance semiconductor die, a pairing of the first functional block and a second functional block of the second set of functional blocks.

In various implementations, the second set of functional blocks are on a single semiconductor die of the multiple semiconductor dies, and this single semiconductor die is different from the higher performance semiconductor die. The configuration control circuit conveys control signals to an interconnect to assign the pairing of the available first functional block and the second functional block. Afterward, circuitry services the request using the pairing of the available first functional block and the second functional block. In some implementations, semiconductor dies (or dies) are chiplets. One or more of these chiplets include one or more functional blocks of either the first set of functional blocks or the second set of functional blocks. However, a “chiplet” is a semiconductor die (or die) fabricated separately from other dies, and then interconnected with these other dies in a single integrated circuit in the multi-chip module (MCM).

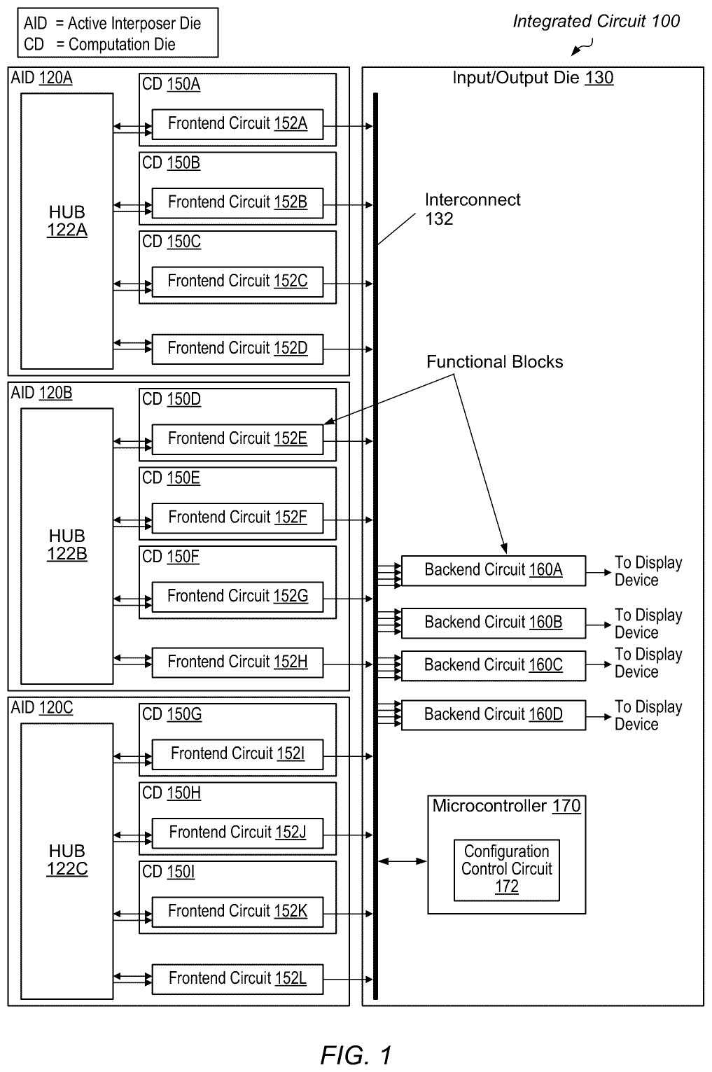

As used herein, a “functional block” is a term that describes blocks, e.g. blocks of circuits that when combined can perform a prescribed functionality, fabricated with other functional blocks on a larger semiconductor die. Therefore, a chiplet includes one or more functional blocks, and a collection of multiple chiplets are placed and connected together within a semiconductor package. Further details of these techniques for efficiently managing performance and power consumption among replicated functional blocks of an integrated circuit despite different circuit behavior amongst the functional blocks due to manufacturing variations are provided in the following description of FIGS. 1-9.

Referring to FIG. 1, a generalized block diagram is shown of an implementation of an integrated circuit 100. A top view of the integrated circuit 100 is provided in FIG. 1. The integrated circuit 100 includes multiple semiconductor dies (or dies) such as the input/output die 130 and the active interposer dies (AIDs) 120A-120C, each with multiple computation dies of the computation dies (CDs) 150A-150I. For example, the active interposer die 120A includes the computation dies 150A-150C, and so on. The frontend circuits 152A-152L are placed on multiple, different dies such as the computation dies 150A-150I and the active interposer dies 120A-120C. The input/output die 130 includes the microcontroller 170, which controls the available paths to use for communication in the interconnect 132. Each of the active interposer dies 120A-120C also includes one of the hubs 122A-122C.

The integrated circuit 100 relies on combinations of the frontend circuits 152A-152L and the backend circuits 160A-160D to provide a particular functionality. In some implementations, the functionality includes the functionality of a display control circuit that receives rendered pixel data, and prepares this pixel data for one or more display devices. In other implementations, other types of functionalities are used based on design requirements. Rather than place the frontend circuits 152A-152L on a same die, such as the input/output die 130, that also includes the backend circuits 160A-160D, the frontend circuits 152A-152L are placed on multiple, different dies such as the computation dies 150A-150I and the active interposer dies 120A-120C. Therefore, differences in behavior across dies and varying number of defects of particular ones of the frontend circuits 152A-152L that result from manufacturing variations across semiconductor dies allows the integrated circuit 100 to still provide high performance.

The microcontroller 170 includes the configuration control circuit 172, which can program, or otherwise set up or assign, the interconnect 132 to form different combinations based on the behavior and yield of the frontend circuits 152A-152L. Each combination includes one or more of the frontend circuits 152A-152L communicating with one of the backend circuits 160A-160D. Each of the hubs 122A-122C includes circuitry that supports communication between the microcontroller 170 and corresponding ones of the frontend circuits 152A-152L. In addition, the hubs 122A-122C retrieve source data for the frontend circuits 152A-152L.

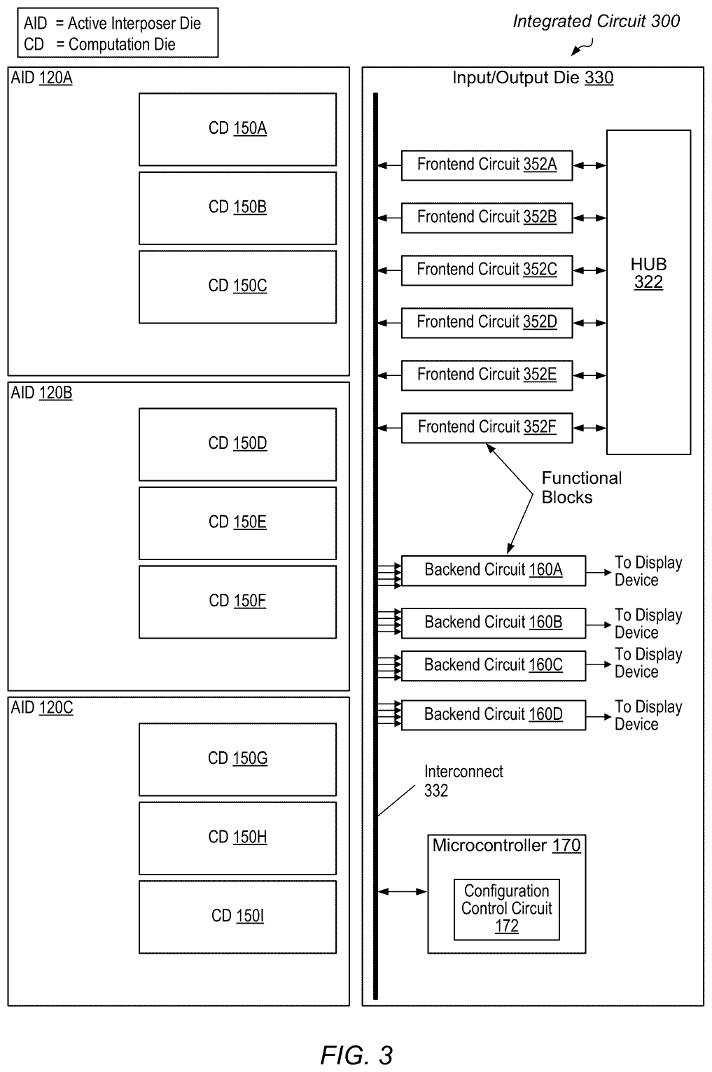

When frontend circuits are placed on a same die, such as the input/output die 130, that also includes the backend circuits 160A-160D, there is less flexibility to create combinations of the frontend circuits and the backend circuits 160A-160D to provide high performance. This scenario is shown and further described in the upcoming integrated circuit 300 (of FIG. 3). In such a scenario, a smaller number of frontend circuits are used in the integrated circuit 100 due to the limited available on-die area of the input/output die 130. When one or more of the frontend circuits has less performance or is unsuitable for use due to manufacturing variations and defects across semiconductor dies, the overall performance of the integrated circuit 100 is limited. However, when the frontend circuits 152A-152L are placed as shown in FIG. 1, the configuration control circuit 172 is able to program the pathways used in the interconnect 132 to maintain a level of high performance.

In some implementations, the backend circuit 160A is connected to a display device that presents multiple windows in a split screen arrangement. In other implementations, the backend circuit 160A is connected to a display device that uses a picture-in-picture feature based on a user request or another type of input. It is possible and contemplated that the backend circuit 160A is connected to a display device that presents both multiple windows in a split screen arrangement and a picture-in-picture feature. In an implementation, a user executes an application on a computing device that uses the integrated circuit 100, and this application automatically initiates the picture-in-picture feature. In some implementations, the user resizes a window currently performing video playback on a screen of a display device allowing the screen to provide a view of a background, another video playback application, or other display. The user can adjust the position of the resized window within the screen through a user interface. In another implementation, the input for the picture-in-picture feature can be from a software stack for a power saving objective. An example is a video playback surface overlay of the desktop background content, which eliminates the surfaces composition pass. Therefore, a request for particular features can be generated by a variety of manners and by a variety of sources. For these implementations, the configuration control circuit 172 selects two of the frontend circuits 152A-152L to perform blending of video data, and to communicate with the backend circuit 160A.

In an implementation, the configuration control circuit 172 selects each of the frontend circuits 152A and 152B to perform blending of video data, and to communicate with the backend circuit 160A. The frontend circuit 152A is in the computation die 150A and the frontend circuit 152B is in the computation die 150B. However, in another implementation, the frontend circuit 152B is unusable due to defects or semiconductor process variations of the computation die 150B that cause the frontend circuit 152B to process data slower than the frontend circuit 152A. In such an implementation, the configuration control circuit 172 selects the frontend circuit 152C in the computation die 150C when the computation die 150C does not include defects and has circuit behavior that supports the frontend circuit 152C to process data at a same data rate as the frontend circuit 152A is in the computation die 150A.

In another implementation, the backend circuit 160B is connected to a display device that uses a double refresh rate such as a 120 hertz (Hz) refresh rate, rather than a 60 Hz refresh rate. The display device is a computer monitor, a television, or other. A user selects a higher refresh rate to reduce blurring of motion of objects, which causes the picture to appear sharper. Therefore, as described earlier, a request for particular features can be generated by a variety of manners and by a variety of sources. It is possible that semiconductor process variations of the computation die 150D cause circuitry of the frontend circuit 152E to be unable to support the higher refresh rate of 120 Hz. Similarly, semiconductor process variations of the computation die 150E cause circuitry of the frontend circuit 152F to be unable to support the higher refresh rate of 120 Hz. However, the frontend circuit 152G in the computation die 150F is able to support the higher refresh rate of 120 Hz. In such a case, the configuration control circuit 172 programs the interconnect 132, or otherwise sets appropriate control signals within the interconnect 132, to combine the frontend circuit 152G with the backend circuit 160B.

In yet another implementation, the backend circuit 160C is connected to a display device that supports a 4K resolution while the backend circuit 160D is connected to a display device that supports a 2K resolution. Each of the display devices is one of a computer monitor, a television, or other. The display device with a 4K resolution supports data processing of almost 4,000 horizontal pixels, or 4K horizontal pixels. The display device with a 4K resolution supports data processing of 3,840 horizontal pixels and 2,160 vertical pixels, which includes millions of pixels. The display device that supports 4K resolution supports data processing of more pixels than another display device that supports 2K resolution. The display device with a 2K resolution supports data processing of 2,560 horizontal pixels and 1,440 vertical pixels. Other display devices that support other resolutions are possible and contemplated.

It is possible that semiconductor process variations between the computation dies 150G and 150H cause circuitry of the frontend circuit 152I to process data at a slower rate than the frontend circuit 152J. In such a case, the configuration control circuit 172 programs the interconnect 132, or otherwise sets appropriate control signals within the interconnect 132, to combine the frontend circuit 152J with the backend circuit 160C that is connected to a display device that supports a 4K resolution. The configuration control circuit 172 also programs the interconnect 132 to combine the frontend circuit 152I with the backend circuit 160D that is connected to a display device that supports a 2K resolution. In another implementation, the circuitry of the active interposer die 120C supports a lower throughput than the circuitry of the computation dies 150G-150I. However, the throughput of the circuitry of the active interposer die 120C supports data processing used to provide 2K resolution for the display device connected to the backend circuit 160D. In such a case, the configuration control circuit 172 can program the interconnect 132 to combine the frontend circuit 152L on the active interposer die 120C with the backend circuit 160D. Afterward, circuitry services the request using the pairing of the frontend circuit 152L on the active interposer die 120C and the backend circuit 160D.

In some implementations, each of the active interposer dies 120A-120C and the computation dies 150A-150I stores a corresponding semiconductor die characterization table (or table). This table includes information that specifies a performance category or bin of the corresponding one of the active interposer dies 120A-120C and the computation dies 150A-150I. In an implementation, the table includes information that specifies a maximum operating clock frequency for the corresponding semiconductor die. In other implementations, the table stores data of a dynamic (adaptive) voltage and frequency scaling curve for the corresponding semiconductor die.

In various implementations, the table that stores the dynamic (adaptive) voltage and frequency scaling curve data or other characterization information is implemented with a fuse array, or a fuse read-only memory (ROM). The fuse ROM utilizes electronic fuses (Efuses) that can be programmed during die characterization in a testing environment, but a continued ability to program is not available in the field. Typically, a fuse is blown at manufacturing time, and its state generally can't be changed once blown. Fuses can be used to encode a variety of types of information such as the dynamic (adaptive) voltage and frequency scaling curve data, manufacturing information, such as a chip serial number and identification of a performance bin, the supported maximum operating clock frequency, and other information. Besides Efuses, it is possible and contemplated that the fuse ROM uses other fuse technologies such as laser and soft fuses. In other implementations, these values are stored in one of a variety of types of a read only memory (ROM) such as an erasable and programmable ROM (EPROM).

During a hardware discovery of a computing system that uses the integrated circuit 100, such as during an initial boot operation of the computing system, the configuration control circuit 172 reads information stored in these tables of the active interposer dies 120A-120C and the computation dies 150A-150I. In an implementation, the configuration control circuit 172 builds a table that the configuration control circuit 172 accesses when assigning one or more of the frontend circuits 152A-152L to one or more of the backend circuits 160A-160D. In another implementation, a host processor (not shown) reads information stored in these tables of the active interposer dies 120A-120C and the computation dies 150A-150I. The host processor builds a table based on this information and sends, to the configuration control circuit 172, the table or an address that points to a storage location that stores the table.

In some implementations, the integrated circuit 100 is a two-dimensional (2D) integrated circuit (IC) with the dies placed in a 2D package. In other implementations, the integrated circuit 100 is a three-dimensional (3D) stacked integrated circuit (IC). The integrated circuit 100 includes a package substrate (not shown) with multiple semiconductor dies (or dies) integrated vertically on top of it. As shown, the multiple dies include the active interposer dies (AIDs) 120A-120C on top of the package substrate. Each of the computation dies (CDs) 150A-150I is placed on top of a corresponding one of the active interposer dies 120A-120C. Additionally, the integrated circuit 100 includes the input/output die 130, which is placed at a same vertical level as the active interposer dies 120A-120C. The input/output die 130 provides access to external devices such as an external memory, an external multimedia circuit, one or more display controllers for one or more video display devices, or otherwise.

The integrated circuit 100 provides high density and heterogeneous semiconductor technology integration in a module or a package. Minimum system board area is used to support the integrated circuit 100, such as an area occupied by the package substrate on a printed circuit board. The integrated circuit 100 is used in a system-in-package (SiP), a multi-chip module (MCM), or other type of packaged product. Although a particular number of components are shown in the illustrated implementation of the integrated circuit 100, in other implementations, another number of components are used, additional components not shown are used, and some components being shown are not used. The choices for the number and types of components being used are based on design requirements. In some implementations, each of the active interposer dies 120A-120C, the computation dies 150A-150I, and the input/output die 130 is a chiplet. It is noted that although the terms “left,” “right,” “horizontal,” “vertical,” “height,” “width,” “row,” “column,” “top,” and “bottom” are used to describe the integrated circuit 100, as used herein, the meaning of the terms can change as the integrated circuit 100 and other circuits in FIGS. 1-9 are rotated, flipped, or otherwise viewed from a different perspective.

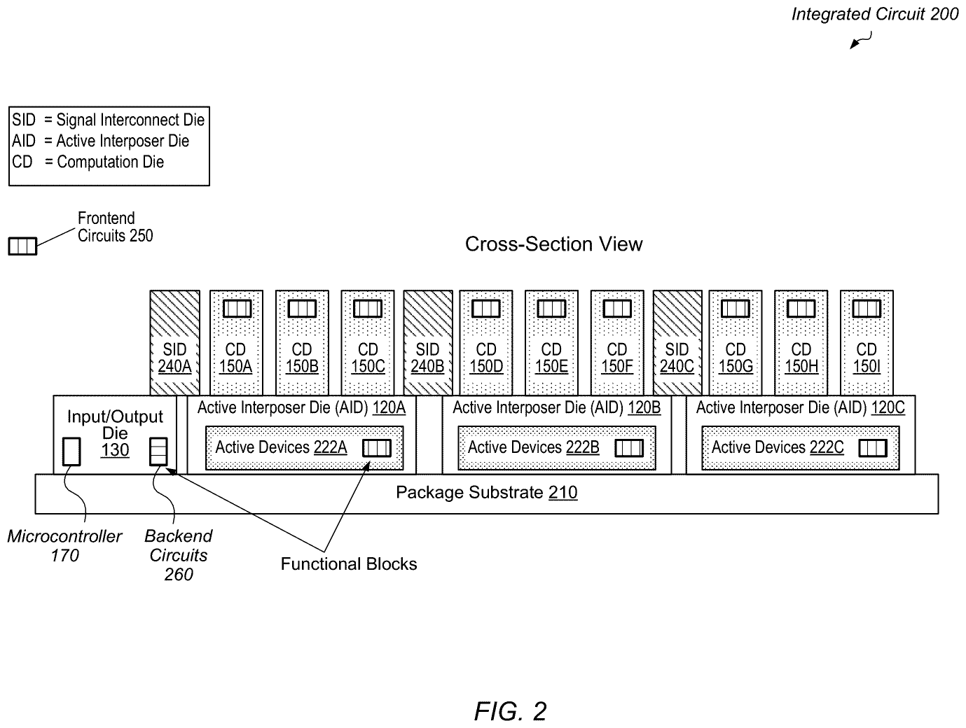

Turning now to FIG. 2, a generalized block diagram is shown of an implementation of an integrated circuit 200. A cross-section view of the integrated circuit 200 is provided in FIG. 2. Circuitry and blocks described earlier are numbered identically. In various implementations, the integrated circuit 200 is a three-dimensional (3D) stacked integrated circuit (IC). The integrated circuit 200 includes a package substrate 210 with multiple semiconductor dies (or dies) integrated vertically on top of it. As shown, the multiple dies include the active interposer dies (AIDs) 120A-120C on top of the package substrate 210. Each of the computation dies (CDs) 150A-150I is placed on top of a corresponding one of the active interposer dies 120A-120C. The integrated circuit 200 includes the input/output die 130, which is placed at a same vertical level as the active interposer dies 120A-120C. Additionally, each of the signal interconnect dies 240A-240C is on top of a corresponding pair of the active interposer dies (AIDs) 120A-120C and the input/output die 130. In various implementations, each of the active interposer dies 120A-120C, the computation dies 150A-150I, the input/output die 130, and the signal interconnect dies 240A-240C is a chiplet.

Although a particular number of components are shown in the illustrated implementation of the integrated circuit 200, in other implementations, another number of components are used, additional components not shown are used, and some components being shown are not used. The choices for the number and types of components being used are based on design requirements. The heights, or thicknesses, of the components as well as the widths of the components are not drawn to scale, and some relationships with dimensions are different than what is shown in FIG. 2. In various implementations, three-dimensional (3D) packaging is used within a computing system. This type of packaging is referred to as a System in Package (SiP). A SiP includes one or more three-dimensional integrated circuits (3D ICs) that includes two or more layers of active electronic components integrated both vertically and/or horizontally into a single circuit. Die-stacking technology is a fabrication process that enables the physical stacking of multiple separate semiconductor dies together in a same package with high-bandwidth and low-latency interconnects. In some implementations, the dies are stacked side by side on a silicon interposer, such as the active interposer dies 120A-120C, and/or vertically directly on top of each other.

The package substrate 210 is apart of the semiconductor chip package that provides mechanical base support as well as provides an electrical interface for the signal interconnects for both dies within the integrated circuit 200 and external devices on a printed circuit board. The packaging substrate 210 uses ceramic materials such as alumina, aluminum nitride, and silicon carbide. The package substrate 210 utilizes controlled collapse chip connection (C4) interconnections (not shown), which is also referred to as flip-chip interconnection. For example, C4 bumps are connected to vertical through silicon vias (TSVs) formed in the package substrate 210 that has connections to the printed circuit board using bump pads.

Groups of TSVs forming through silicon buses are used as interconnects between a base die, one or more additional integrated circuits, and routing on a printed circuit board (PCB) such as a motherboard or a card. Through silicon buses are used as a vertical electrical connection traversing through a silicon wafer and provide alternative interconnect to wire-bond and flip chips. The size and density of the vertical interconnects, such as TSVs and through silicon buses, that can tunnel between the different device layers varies based on the underlying technology used to fabricate the 3D ICs. The demand for SiPs and more signal interconnects between the integrated circuits and the printed circuit board (PCB) also increases the demand for package substrates and interposers.

In some implementations, the integrated circuit 200 includes redistribution layers between the package substrate 210 and the active interposer dies 120A-120C. The redistribution layers include signal routes using multiple metal layers and vias that provide physical connection between adjacent metal layers of the redistribution layers. Dielectric material, such as silicon dioxide, is also used between adjacent metal layers and within metal layers to provide electrical insulation between signal routes. Generally speaking, an interposer is an intermediate layer between the computation dies 150A-150I and either flip chip bumps or other interconnects and the package substrate 210. An interposer can be manufactured using silicon or organic materials.

The active interposer dies 120A-120C can provide multiple, large channels for signal routes, which reduces the power consumed to drive signals, minimizes the resistance and capacitance effects on signal routes, and reduces the distances of signal interconnects between the signal interconnect dies 240A-240C and the computation dies 150A-150I. For example, the active interposer dies 120A-120C provide the electrical interface for the signal interconnects between the one or more dies assembled on it (die-to-die interconnects), such as the signal interconnect dies 240A-240C and the computation dies 150A-150I, and the package substrate 210 (die-to-package interconnects). Similar to the package substrate 210 and any redistribution layers, the active interposer dies 120A-120C also use TSVs and through silicon buses.

Each of the computation dies 150A-150I include circuitry for processing data such as one or more processor cores. These one or more processor cores provide the functionality of one of a central processing unit (CPU) with a general-purpose microarchitecture, a graphics processing unit (GPU) with a highly parallel data microarchitecture, an accelerated processing unit (APU), a digital signal processor (DSP), a field programmable gate array (FPGA), an application specific integrated circuit (ASIC), or other. In some implementations, each of the computation dies 150A-150I has a same microarchitecture. However, in various other implementations, at least one of the computation dies 150A-150I has a microarchitecture distinct from other dies of the computation dies 150A-150I. In an implementation, one or more of the computation dies 150A-150I provides the functionality of a shader circuit within a shader array of a GPU. The computation dies 150A-150I are used in a computing system that communicates with other chips on a printed circuit board within a laptop computer, a smart phone, a tablet computer, a desktop computer, a server; or other.

Each of the signal interconnect dies (SIDs) 240A-240C includes a relatively small semiconductor die that provides signal interconnections between two other separate semiconductor dies within a semiconductor package. Therefore, the signal interconnect dies 240A-240C provide more input/output signal communication within the semiconductor package, which reduces the memory bandwidth bottleneck in the integrated circuit 200. As shown, the signal interconnect die 240A provides input/output signal communication between the computation dies 150A-150C and the input/output die 130. The input/output die 130 provides access to external devices such as an external memory, an external multimedia circuit, one or more display controllers for one or more video display devices, or otherwise. The signal interconnect die 240B provides input/output signal communication between the computation dies 150A-150C and the computation dies 150D-150F. The signal interconnect die 240C provides input/output signal communication between the computation dies 150D-150F and the computation dies 150G-150I.

Each of the active interposer dies 120A-120C includes signal interconnects, embedded passive components, such as inductors and decoupling capacitors, voltage regulators, and active devices (or transistors). As shown, the active interposer die 120A includes the active devices 222A, the active interposer die 120B includes the active devices 222B, and the active interposer die 120C includes the active devices 222C. As used herein, a “transistor” is also referred to as a “semiconductor device,” an “active device,” or a “device.” The integrated circuit 100 uses p-type metal oxide semiconductor (PMOS) field effect transistors FETS (or pfets) in addition to n-type metal oxide semiconductor (NMOS) FETS (or nfets). In some implementations, the devices (or transistors) in the integrated circuit 100 are planar devices. In other implementations, the devices (or transistors) in the integrated circuit 100 are non-planar devices. Examples of non-planar transistors are tri-gate transistors, fin field effect transistors (FIN FETs), and gate all around (GAA) transistors.

Each of the active devices 222A-222C of the active interposer dies 120A-120C includes circuitry that supports a memory controller and an input/output (I/O) communication fabric between the computation dies 150A-150I and the memory controller. The active devices 222A-222C in the active interposer dies 120A-120C implement queues for storing memory access requests, memory access responses, messages, snoop requests, snoop responses, packets that include a variety of types of requests, responses, commands, and so forth. The active devices 222A-222C in the active interposer dies 120A-120C also implement network switches (or routers) of the communication fabric that includes arbitration circuitry, signal drivers, interface circuitry, clock generating circuitry, configuration registers, and so forth.

Additionally, the active devices 222A-222C implement a particular hierarchy of a multi-hierarchical cache memory subsystem such as a corresponding level three (L3) cache. For example, the active interposer die 120A includes a level three (L3) cache that can be accessed by any of the computation dies 150A-150I. Similarly, each of the active interposer dies 120B-120C includes a corresponding L3 cache that can be accessed by any of the computation dies 150A-150I. In other implementations, the hierarchical level of the cache implemented in the active interposer dies 120B-120C is different from an L3 cache. Further, the active devices 222A-222C in the active interposer dies 120A-120C also implement the frontend circuits 250. In various implementations, the frontend circuits 250 of the active interposer dies 120A-120C provide the same functionality as the frontend circuits 152A-152L (of FIG. 1). Similarly, the backend circuits 260 of the input/output die 130 provide the same functionality as the backend circuits 160A-160D (of FIG. 1).

In various implementations, a semiconductor fabrication process places a particular number of computation dies on each active interposer die placed in an integrated circuit. Additionally, the semiconductor fabrication process places a particular number of frontend circuits in each active interposer die. In various implementations, the semiconductor fabrication process places three computation dies on each active interposer die, and places a single frontend circuit in each active interposer die as shown in the integrated circuit 100 (of FIG. 1) and the integrated circuit 200 (of FIG. 2). In some implementations, for a first integrated circuit, the computation dies are from a first performance category (or first bin) that includes a frontend circuit capable of supporting processing data, such as rendering video pixel data, for a display device that supports a 2K resolution and a refresh rate of 60 Hz. The active interposer dies of the first integrated circuit are from a second performance category (or second bin) that includes a frontend circuit capable of providing the same performance as frontend circuits of the computation dies from the first bin. For a second integrated circuit, the computation dies are from a third category (or third bin) that includes a frontend circuit capable of supporting processing data, such as rendering video pixel data, for a display device that supports a 4K resolution and a refresh rate of 120 Hz. The active interposer dies of the second integrated circuit are from a fourth performance category (or fourth bin) that includes a frontend circuit capable of providing the same performance as frontend circuits of the computation dies from the third bin.

Regarding the above two integrated circuits, each connected to a same number of display devices, to provide a same available performance for each of the first integrated circuit and the second integrated circuit, the semiconductor fabrication process places three active interposer dies on the first integrated circuit and two active interposer dies on the second integrated circuit. In another implementation, the semiconductor fabrication process places another number of active interposer dies on the first integrated circuit that is greater than a number of active interposer dies on the second integrated circuit. The ratio of the number of active interposer dies on the first integrated circuit to the number of active interposer dies on the second integrated circuit is based on the ratio of performances provided by the respective active interposer dies and computation dies from different bins as well as the maximum number of available display devices.

The ratio can also be based on a number of frontend circuits that are defective, yet a corresponding computation die or active interposer die is still placed in one of the first integrated circuit and the second integrated circuit. Therefore, despite having a defective frontend circuit that can't be used, a corresponding computation die or active interposer die is still used in a chip. Other frontend circuits of the chip are used for mappings between frontend circuits and backend circuits, but the placement of the corresponding computation die or active interposer die increases the semiconductor wafer yield. The microcontrollers of each of the first integrated circuit and the second integrated circuit are capable of generating the assignments of combinations (or mappings) between frontend circuits and backend circuits to provide the same performances for the available display devices. By placing chiplets from different bins on the integrated circuits in a particular manner, the semiconductor fabrication process is able to provide integrated circuits that provide a same overall performance despite the chiplets being selected from different bins.

Referring to FIG. 3, a generalized block diagram is shown of an implementation of an integrated circuit 300. A top view of the integrated circuit 300 is provided in FIG. 3. Circuitry and blocks described earlier are numbered identically. In contrast to the integrated circuit 100 (of FIG. 1) shown earlier, the integrated circuit 300 includes all frontend circuits 352A-352F in the input/output circuit 330 with no frontend circuits in the computation dies 150A-150I and with no frontend circuits in the active interposer dies 120A-120C. Similarly, the input/output circuit 330 includes a single hub 332, and each of the active interposer dies 120A-120C and the computation dies 150A-150I has no hubs. In various implementations, the hub 332 has the same functionality as the hubs 122A-122C (of FIG. 1). The input/output die 330 provides access to external devices such as an external memory, an external multimedia circuit, one or more display controllers for one or more video display devices, or otherwise. Although the input/output circuit 330 includes six frontend circuits 352A-352F, in other implementations, the input/output circuit 330 includes another number of frontend circuits based on design requirements.

The integrated circuit 300 relies on combinations of the frontend circuits 352A-352F and the backend circuits 160A-160D to provide a particular functionality. In some implementations, the functionality includes the functionality of a display control circuit that receives rendered pixel data, and prepares this pixel data for one or more display devices. In other implementations, other types of functionalities are used based on design requirements. When each of the frontend circuits 352A-352F are placed on a same die, such as the input/output die 330, that also includes the backend circuits 160A-160D, there is less flexibility to create combinations of the frontend circuits 352A-352F and the backend circuits 160A-160D to provide high performance. For example, it is possible that at least one of the frontend circuits 352A-352F is defective and does not function due to manufacturing variations across semiconductor dies. In addition, it is possible that at least one of the frontend circuits 352A-352F has different circuit behavior from others of the frontend circuits 352A-352F.

The differences in circuit behavior result from manufacturing variations across semiconductor dies that inadvertently cause different widths of metal gates and metal traces, different doping levels of source and drain regions, different thicknesses of insulating oxide layers, different thicknesses of metal layers, and so on. These manufacturing variations also affect the threshold voltages of transistors. When the semiconductor package utilizes multiple copies of a same semiconductor die and even when the multiple copies receive a same workload, the behavior of the resulting semiconductor chip can vary depending on which bins the semiconductor dies were selected to be placed in the semiconductor chip.

If one or more of the frontend circuits 352A-352F is defective and provides no functionality, the configuration control circuit 172 of the microcontroller 170 has less flexibility to create combinations of the frontend circuits 352A-352F and the backend circuits 160A-160D to provide requested functionality at a desire performance level. For example, if the frontend circuit 352B is defective, then there are only five available frontend circuits of the frontend circuits 352A-352F. A user is unable to request two display devices of the four display devices to use the picture-in-picture feature while requesting two other display devices use a higher refresh rate (e.g., 120 Hz or higher). These requests require all six of the frontend circuits 352A-352F. Therefore, the integrated circuit 300 is placed in a computing system of a product that offers less functionality. In contrast, the integrated circuit 100 (of FIG. 1) can have one or more frontend circuits that are defective and have one or more frontend circuits that provide lower performance, but the microcontroller 170 is still able to create combinations of the available ones of the frontend circuits 152A-152L and the backend circuits 160A-160D to provide requested functionality at a desire performance level.

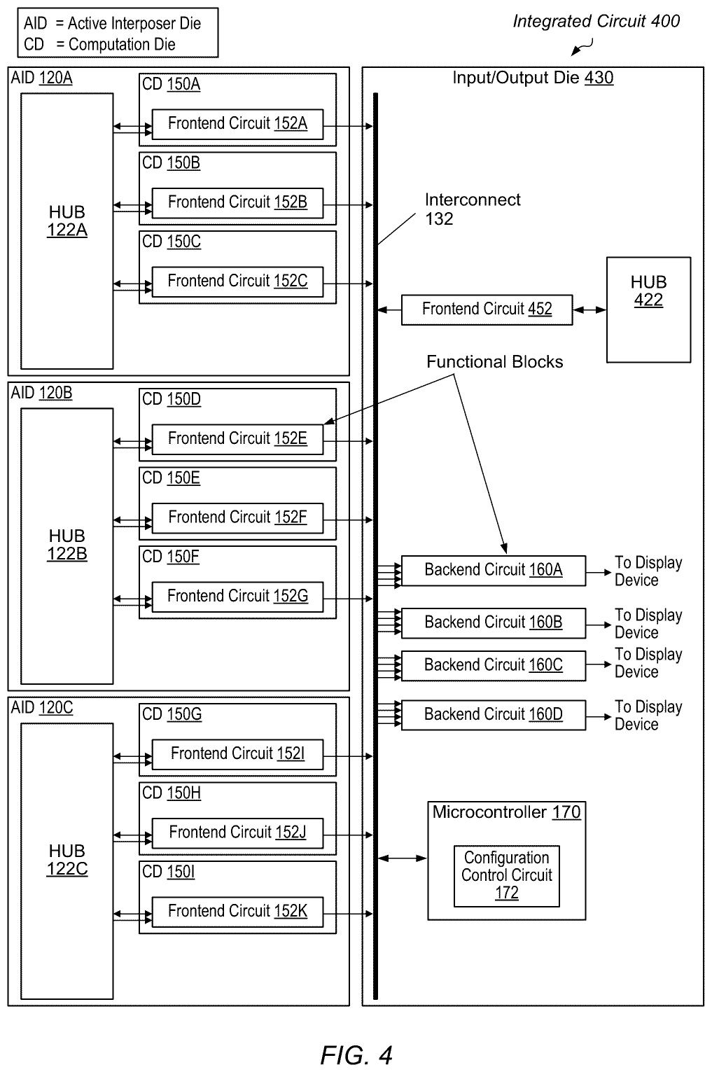

Turning now to FIG. 4, a generalized block diagram is shown of an implementation of an integrated circuit 400. A top view of the integrated circuit 400 is provided in FIG. 4. Circuitry and blocks described earlier are numbered identically. In contrast to the integrated circuit 100 (of FIG. 1) shown earlier, the integrated circuit 400 includes a frontend circuit 452 in the input/output circuit 430 with no frontend circuits in the active interposer dies 120A-120C. The input/output circuit 430 includes a single hub 432 that has the same functionality as the same functionality as the hubs 122A-122C (of FIG. 1) and the hub 332 (of FIG. 3). Similarly, the frontend circuit 452 has the same functionality as the frontend circuits 152A-152L (of FIG. 1) and the frontend circuits 352A-352F (of FIG. 3). The integrated circuit 400 provides another distribution of frontend circuits where at least one frontend circuit is not placed in the input/output circuit 430. The configuration control circuit 172 is able to program the interconnect 132, or otherwise set appropriate control signals within the interconnect 132, to combine the available ones of the frontend circuits 152A-152C, 152E-152G, 152I-152K and 452 with the backend circuits 160A-160D to support endpoint features requests. Afterward, circuitry services the received endpoint features request using the selected combination of one or more of the frontend circuits 152A-152C, 152E-152G, 152I-152K and 452 and one of the backend circuits 160A-160D.

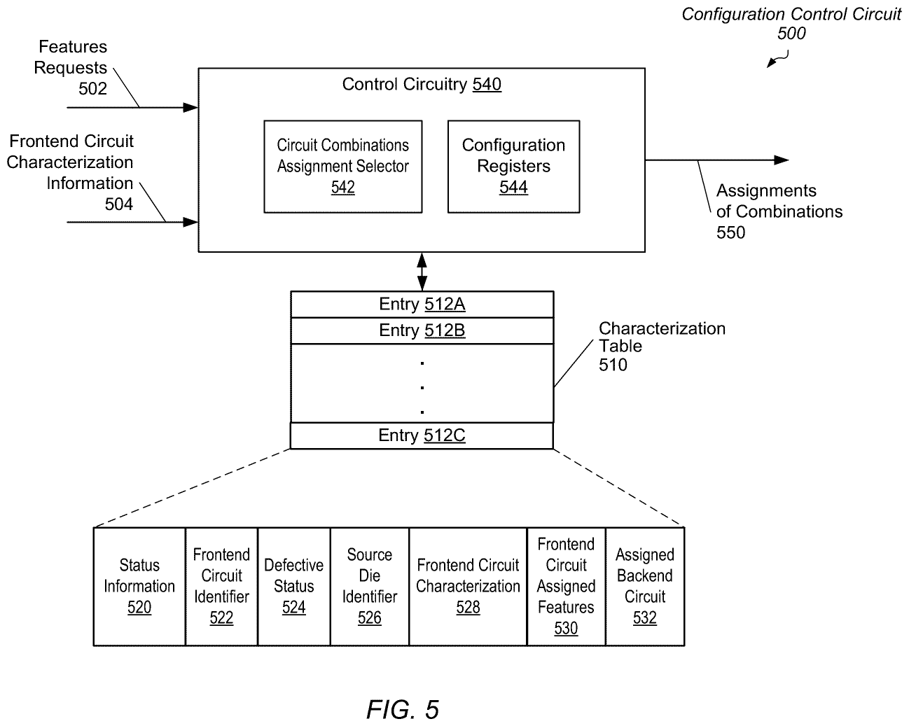

Turning now to FIG. 5, a generalized block diagram is shown of a configuration control circuit 500 that efficiently manages performance among replicated functional blocks of an integrated circuit despite different circuit behavior of the functional blocks due to manufacturing variations. As shown, the configuration control circuit 500 (or circuit 500) includes the characterization table 510 and the control circuitry 540. In an implementation, the circuit 500 is included in a microcontroller of a particular semiconductor die of multiple semiconductor dies of an integrated circuit. In some implementations, the circuit 500 builds the characterization table 510 during a hardware discovery step of a bootup operation. The circuit 500 reads a table, such as a fuse array or another set of data storage elements, in each of the multiple semiconductor dies that identifies a performance level of a corresponding semiconductor die. This information is sent as the frontend circuit characterization information 504.

The characterization table 510 (or table 510) is implemented with one of flip-flop circuits, one of a variety of types of a random-access memory (RAM), a content addressable memory (CAM), or other. The table 510 includes table entries 512A-512C (or entries 512A-512C), and each of the entries 512A-512C stores information in fields 520-532. Although particular information is shown as being stored in the fields 520-532, and in a particular contiguous order, in other implementations, a different order is used and a different number and type of information is stored. The field 520 stores table entry status information such as at least a valid bit indicating whether the table entry is allocated. The field 522 stores an identifier of a particular frontend circuit of multiple frontend circuits of the integrated circuit. The field 524 stores an indication of whether the particular frontend circuit is defective. It is possible that during semiconductor fabrication manufacturing that one or more frontend circuits on a particular semiconductor die are defective. The semiconductor process variations can accidentally cause electrical open circuits, electrical short circuits, and so forth. However, with one or more frontend circuits able to function on the particular semiconductor die, the particular semiconductor die is still used and it is placed in the integrated circuit.

The field 526 stores an identifier of the particular semiconductor die that includes the particular frontend circuit corresponding to the table entry. The field 528 stores characterization information, such as an indication of a performance level, of the particular frontend circuit. This performance level is the associated with the performance level of the particular semiconductor die. As described earlier, the performance level can be indicated by a maximum operating clock frequency supported by the particular semiconductor die, a dynamic (adaptive) voltage and frequency scaling curve for the particular semiconductor die, and so forth. The field 530 stores an indication of any features assigned to the particular frontend circuit. Examples of the endpoint features are a picture-in-picture feature for a first display device, a higher refresh rate for a second display device, a particular resolution for a third display device, and so forth. The field 532 stores an identifier of a backend circuit that is assigned to be paired with the particular frontend circuit.

The control circuitry 540 receives endpoint features requests 502. In an implementation, the control circuitry 540 receives endpoint features requests 502 during a bootup operation (warm or cold bootup). In other implementations, the control circuitry 540 receives endpoint features requests 502 as display devices are added to and removed from a computing system that uses the integrated circuit that includes the circuit 500. In various implementations, an indication of the addition or removal of display devices is provided in the endpoint features requests 502. In other implementations, a separate input to the control circuitry 540 includes such an indication. As described earlier, examples of the endpoint features requests 502 are a picture-in-picture feature for a first display device, a higher refresh rate for a second display device, a particular resolution for a third display device, and so forth. In other implementations, other examples for other types of endpoint devices are possible and contemplated. The endpoint features specified in the endpoint features requests 502 indicate a performance level required by the endpoint features requests 502. In some implementations, this performance level is compared to the performance levels indicated in field 530 of the entries 512A-512C of the characterization table 510. In an implementation, the actual endpoint features specified in the endpoint features requests 502 are also compared to the endpoint features indicated in the field 532 of the entries 512A-512C of the characterization table 510.

The circuit combinations assignment selector 542 (or selector 542) generates the assignments of combinations 550 (or assignments 550) based on the received endpoint features requests 502, information stored in the table 510, and information stored in the configuration registers 544. The configuration registers 544 can store information such as currently used operating parameters of one or more semiconductor dies, a currently used power limit, currently used utilization values of frontend circuits of the semiconductor dies, and so forth. In an implementation, each of multiple frontend circuits supports processing data, such as rendering video pixel data, for a display device that supports a 4K resolution and a refresh rate of 120 Hz. A backend circuit is connected to a display device that supports a 4K resolution and a refresh rate of 480 Hz. The selector 542 selects four of these frontend circuits to form a combination with the backend circuit in order to support the display device. The control circuitry 540 also generates control signals to direct how to provide input data to the four frontend circuits in order to support the display device. In another implementation, a backend circuit is connected to a display device that supports a 16K resolution and a refresh rate of 120 Hz. The selector 542 selects four of the frontend circuits to form a combination with the backend circuit in order to support the display device. The control circuitry 540 also generates control signals to direct how to provide input data to the four frontend circuits in order to support the display device.

As described, the control circuitry 540 uses the assignments 550 to generate control signals to send to an interconnect to connect functional blocks of the assignments 550. In the above examples, the control circuitry 540 generates control signals to direct how to provide input data to the four frontend circuits Additionally, the control circuitry 540 uses the assignments 550 to update the table 510. As described earlier, the table 510 is built or updated during a bootup operation, and the table 510 is updated as display devices are added to and removed from a computing system that uses the integrated circuit that includes the circuit 500. Therefore, the control circuitry 540 provides dynamic updates of the assignments 550, or a dynamic mapping of frontend circuits to backend circuits.

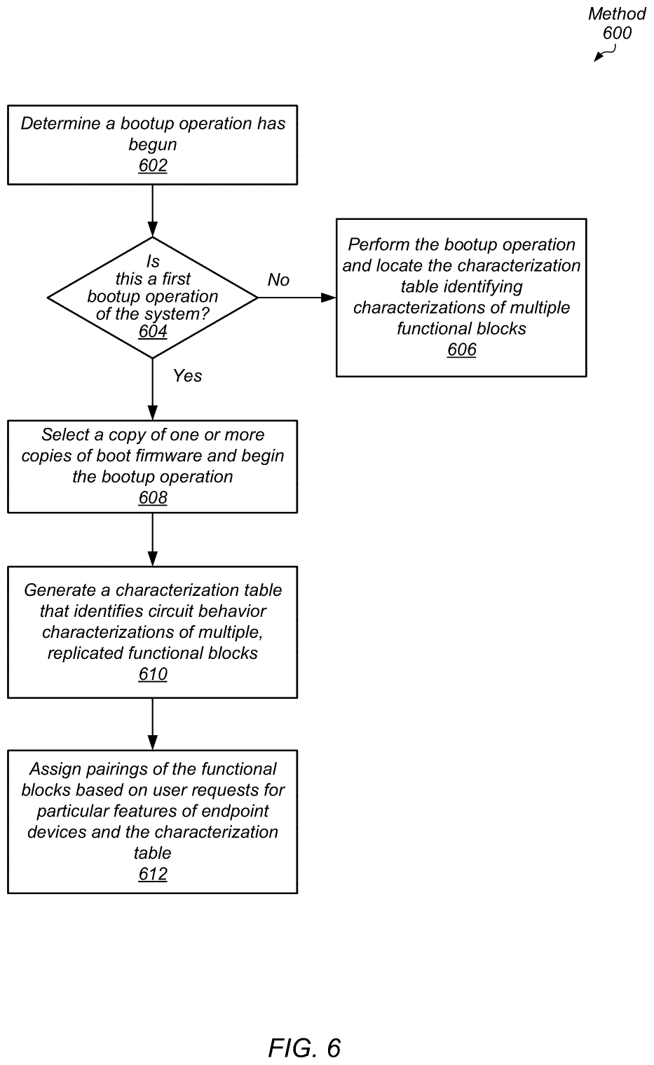

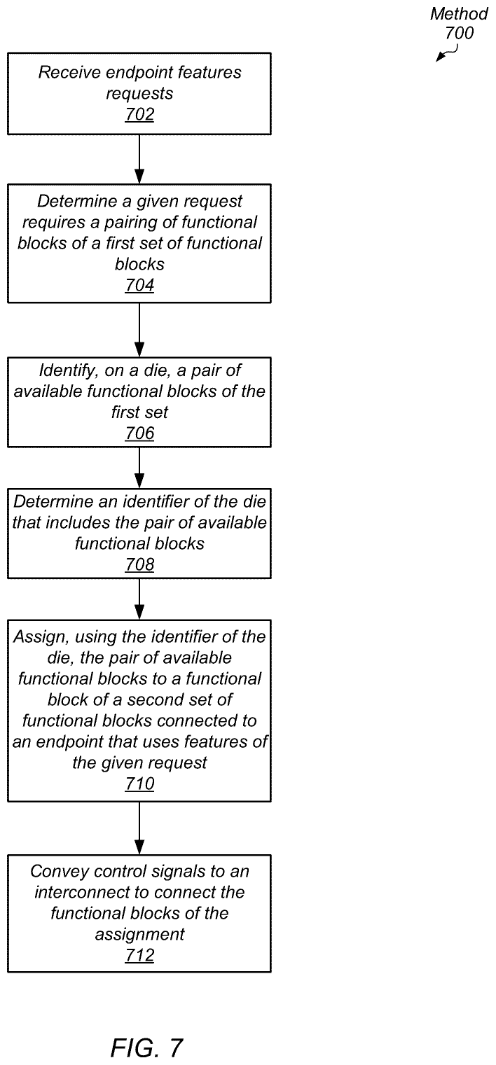

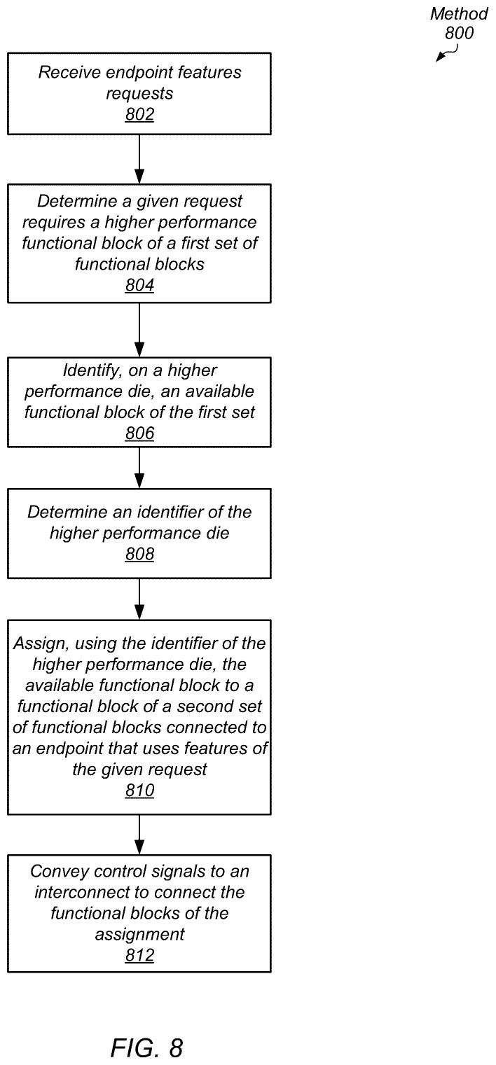

Referring now to FIG. 6, a generalized block diagram is shown of a method 600 for efficiently managing performance among replicated functional blocks of an integrated circuit despite different circuit behavior of semiconductor dies due to manufacturing variations. For purposes of discussion, the steps in this implementation (as well as in FIGS. 7-8) are shown in sequential order. However, in other implementations some steps occur in a different order than shown, some steps are performed concurrently, some steps are combined with other steps, and some steps are absent.

An integrated circuit includes multiple semiconductor dies. The multiple semiconductor dies include a first set of functional blocks with each representing an instantiated copy of integrated circuitry that processes a first portion of one or more tasks. The multiple semiconductor dies also include a second set of functional blocks with each representing an instantiated copy of integrated circuitry that processes a second portion of the one or more tasks. In some implementations, each of the first set of functional blocks is a frontend circuit that processes rendered video data, and each of the second set of functional blocks is a backend circuit that processes data generated by the first functional block. Additionally, each of the second set of functional blocks is connected to an endpoint device such as a display device. A security processor of the integrated circuit determines a bootup operation has begun (block 602). The bootup operation is either a cold bootup operation or a warm bootup operation.

A cold bootup operation occurs when the computing device has been switched off, or otherwise had its power supply removed. A warm bootup operation occurs when the computing device maintains connection to its power supply without interruption, but the user restarts the computing device through a provided command or a particular input key sequence on the keyboard. If the security processor determines that this is not a first bootup operation of the system such as a first-ever bootup operation of the computing system (“no” branch of the conditional block 604), then the security processor performs the bootup operation and locates the characterization table identifying characterizations of the multiple, replicated functional blocks of the first set and the second set (block 606). The security processor uses one or more signatures of boot firmware for validation. The security processor can also determine that this is not a first bootup operation of the system by searching for and finding signatures corresponding to copies of boot firmware.

If the security processor determines that this is a first bootup operation of the system such as a first-ever bootup operation of the computing system (“yes” branch of the conditional block 604), then the security processor selects a copy of one or more copies of boot firmware, and generates a signature for the selected copy to be used for validation of subsequent bootup operations (block 608). At a later time, one or more of a host processor, a microcontroller, or other generates a characterization table that identifies circuit behavior characterizations of the multiple, replicated functional blocks of the first set and the second set (block 610). One of the host processor, the microcontroller, or other reads a table, such as a fuse array or another set of data storage elements, in each of the multiple semiconductor dies that identifies a performance level of a corresponding semiconductor die.

In an implementation, a table of a corresponding semiconductor die specifies a maximum operating clock frequency of the corresponding semiconductor die, which is used to characterize the corresponding semiconductor die. For example, an indication of 2.0 gigahertz (GHz) for a semiconductor die can be used to identify the semiconductor die as being from a higher performance bin. In contrast, an indication of 1.6 GHz for a semiconductor die can be used to identify the semiconductor die as being from a lower performance bin. In some implementations, the table stores data of a dynamic (adaptive) voltage and frequency scaling curve for the corresponding semiconductor die. A configuration control circuit in the host processor, the microcontroller, or other builds a characterization table based on the information read from the tables of the semiconductor dies.

The configuration control circuit assigns pairings of the functional blocks based on user requests for particular features of endpoint devices and the characterization table (block 612). Therefore, the configuration control circuit generates mappings between frontend circuits and backend circuits based on features of the display devices. In an implementation, a functional block that provides a backend circuit is connected to a display device that uses a picture-in-picture feature based on a user request or other input. The configuration control circuit selects two functional blocks that provide two frontend circuits to perform blending of video data, and to communicate with the backend circuit. The configuration control circuit uses the characterization table to perform the selection. The two frontend circuits are on a semiconductor die that is different from a semiconductor die that includes the backend circuit. It is noted that although the description for method 600 is directed to a bootup operation, in other implementations, the steps performed in blocks 610 and 612 are performed as display devices are added to and removed from a computing system that uses the integrated circuit that includes the first set of functional blocks and the second set of functional blocks.

For each of the method 700 (of FIG. 7) and the method 800 (of FIG. 8), an integrated circuit includes multiple semiconductor dies. The multiple semiconductor dies include a first set of functional blocks and a second set of functional blocks. Each of the first set of functional blocks is a frontend circuit that processes rendered video data, and each of the second set of functional blocks is a backend circuit that processes data generated by the first functional block. Each of the second set of functional blocks is connected to an endpoint device such as a display device. The steps performed in each of the method 700 (of FIG. 7) and the method 800 (of FIG. 8) are performed during one or more of a bootup operation and as display devices are added to and removed from a computing system that uses the integrated circuit that includes the first set of functional blocks and the second set of functional blocks. Turning now to FIG. 7, a generalized block diagram is shown of a method 700 for efficiently managing performance among replicated functional blocks of an integrated circuit despite different circuit behavior of semiconductor dies due to manufacturing variations. A configuration control circuit of the integrated circuit receives endpoint features requests (block 702). Examples of the endpoint features requests are a picture-in-picture feature for a first display device, a higher refresh rate for a second display device, a particular resolution for a third display device, and so forth.

The configuration control circuit determines a given request requires a pairing of functional blocks of a first set of functional blocks (block 704). For example, a picture-in-picture feature for a particular display device requires two frontend circuits working together to provide video data to the particular display device. The endpoint features specified in the endpoint features requests indicate a performance level required by the endpoint features requests. In some implementations, this performance level is compared to performance levels indicated in a particular field of entries of a characterization table. In an implementation, the actual endpoint features specified in the endpoint features requests are also compared to the endpoint features indicated in another field of entries of the characterization table.

The configuration control circuit identifies, on a die, a pair of available functional blocks (frontend circuits) of the first set (block 706). In some implementations, the configuration control circuit accesses a characterization table that was built during a bootup operation and updated as display devices are added to and removed from a computing system that uses the integrated circuit that includes the first set of functional blocks and the second set of functional blocks. The characterization table includes at least status information (assigned or not assigned) of functional blocks and performance levels of semiconductor dies. The configuration control circuit determines an identifier of the semiconductor die that includes the pair of available functional blocks (block 708).

The configuration control circuit assigns, using the identifier of the semiconductor die, the pair of available functional blocks (frontend circuits) to a functional block (backend circuit) of the second set of functional blocks connected to an endpoint that uses features of the given request (block 710). Therefore, the configuration control circuit generates mappings between frontend circuits and backend circuits based on features of the display devices. The configuration control circuit conveys control signals to an interconnect to connect the functional blocks of the assignment (block 712).

Referring to FIG. 8, a generalized block diagram is shown of a method 800 for efficiently managing performance among replicated functional blocks of an integrated circuit despite different circuit behavior of semiconductor dies due to manufacturing variations. A configuration control circuit of the integrated circuit receives endpoint features requests (block 802). Examples of the endpoint features requests are a picture-in-picture feature for a first display device, a higher refresh rate for a second display device, a particular resolution for a third display device, and so forth.

The configuration control circuit determines a given request requires a higher performance functional block (frontend circuit) of a first set of functional blocks (block 804). The configuration control circuit identifies, on a higher performance semiconductor die, an available functional block of the first set (block 806). In some implementations, the configuration control circuit accesses a characterization table that was built during a bootup operation and updated as display devices are added to and removed from a computing system that uses the integrated circuit that includes the first set of functional blocks and the second set of functional blocks.

The configuration control circuit determines an identifier of the higher performance semiconductor die (block 808). The configuration control circuit assigns, using the identifier of the higher performance semiconductor die, the available functional block to a functional block of a second set of functional blocks connected to an endpoint that uses features of the given request (block 810). Therefore, the configuration control circuit generates mappings between frontend circuits and backend circuits based on features of the display devices. The configuration control circuit conveys control signals to an interconnect to connect the functional blocks of the assignment (block 812).

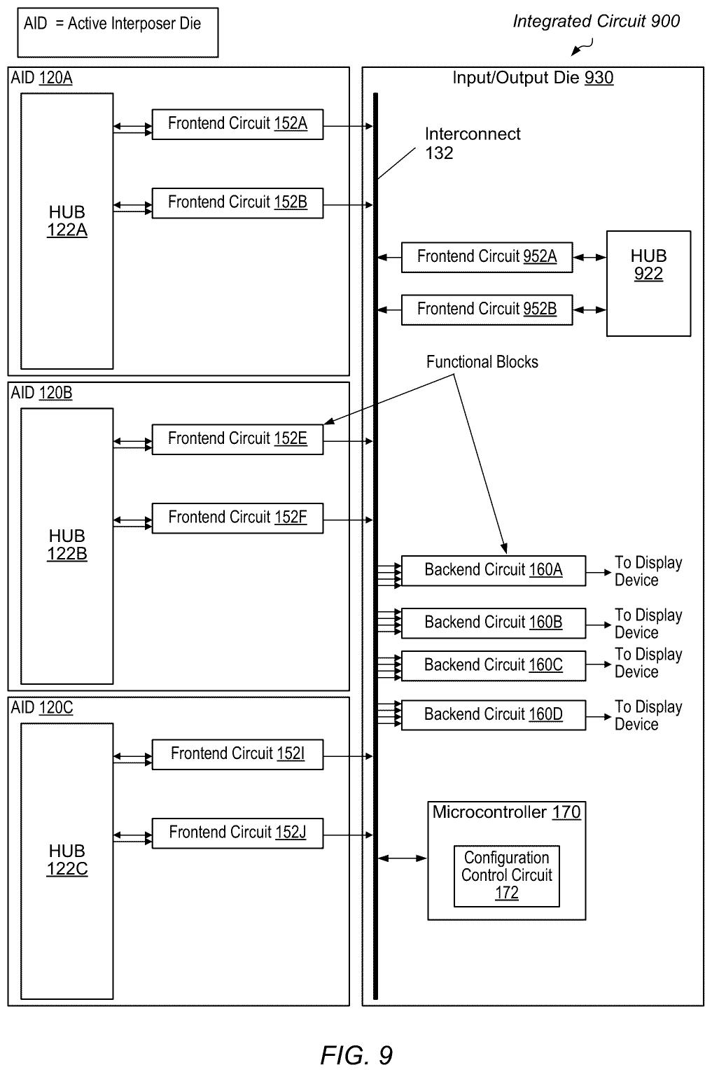

Turning now to FIG. 9, a generalized block diagram is shown of an implementation of an integrated circuit 900. A top view of the integrated circuit 900 is provided in FIG. 9. Circuitry and blocks described earlier are numbered identically. In contrast to the integrated circuit 100 (of FIG. 1) shown earlier, the integrated circuit 900 includes frontend circuits 952A-952B in the input/output circuit 930 and the active interposer dies 120A-120C do not include any computation dies. Each of the active interposer dies 120A-120C includes two frontend circuits. For example, the active interposer die 120A includes the computation dies 150A-150B, and so on. The input/output circuit 930 includes a single hub 932 that has the same functionality as the same functionality as the hubs 122A-122C (of FIG. 1), the hub 332 (of FIG. 3), and the hub 432 (of FIG. 4). Similarly, the frontend circuits 952A-952B has the same functionality as the frontend circuits 152A-152L (of FIG. 1), the frontend circuits 352A-352F (of FIG. 3), and the frontend circuits 152A-152C, 152E-152G, 152I-152K and 452 (of FIG. 4). The integrated circuit 900 provides another distribution of frontend circuits where at least one frontend circuit is not placed in the input/output circuit 930. The configuration control circuit 172 is able to program the interconnect 132, or otherwise set appropriate control signals within the interconnect 132, to combine the available ones of the frontend circuits 152A-152B, 152E-152F, 152I-152J and 952A-952B with the backend circuits 160A-160D to support endpoint features requests.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An integrated circuit comprising:
circuitry configured to:
receive a request;
service the request using a first functional block and a second functional block, responsive to the request requiring a first performance level; and
service the request using the first functional block and a third functional block different from the second functional block, responsive to the request requiring a second performance level different from the first performance level.

2. The integrated circuit as recited in claim 1, further comprising a plurality of semiconductor dies, wherein the second functional block and the third functional block are located on different semiconductor dies of the plurality of semiconductor dies.

3. The integrated circuit as recited in claim 2, wherein the circuitry is further configured to determine a performance level of the request based on endpoint features specified in the request.

4. The integrated circuit as recited in claim 2, wherein the circuitry is further configured to determine a performance level of one or more functional blocks based on identifiers of the functional blocks.

5. The integrated circuit as recited in claim 4, wherein one or more semiconductor dies of the plurality of semiconductor dies provide a different performance level than other semiconductor dies of the plurality of semiconductor dies.

6. The integrated circuit as recited in claim 4, wherein the circuitry is further configured to:
generate a mapping between the first functional block and the second functional block, responsive to the request requiring the first performance level; and
convey control signals based on the mapping to an interconnect to connect the first functional block to the second functional block.

7. The integrated circuit as recited in claim 4, wherein:
the first functional block is connected to an endpoint device that uses data generated by tasks requiring a performance level of the request;
each of the second functional block and the third functional block is an instantiated copy of a frontend circuit that processes rendered video data; and
the first functional block is a backend circuit that processes data generated by the frontend circuit.

8. A method comprising:
receiving a request by circuitry;
servicing, by the circuitry, the request using a first functional block and a second functional block, responsive to the request requiring a first performance level; and
servicing, by the circuitry, the request using the first functional block and a third functional block different from the second functional block, responsive to the request requiring a second performance level different from the first performance level.

9. The method as recited in claim 8, further comprising processing tasks by a plurality of semiconductor dies, wherein the second functional block and the third functional block are located on different semiconductor dies of the plurality of semiconductor dies.

10. The method as recited in claim 9, further comprising determining, by the circuitry, a performance level of the request based on endpoint features specified in the request.

11. The method as recited in claim 9, further comprising determining, by the circuitry, a performance level of one or more functional blocks based on identifiers of the functional blocks.

12. The method as recited in claim 11, wherein one or more semiconductor dies of the plurality of semiconductor dies provide a different performance level than other semiconductor dies of the plurality of semiconductor dies.

13. The method as recited in claim 11, further comprising:
generating, by the circuitry, a mapping between the first functional block and the second functional block, responsive to the request requiring the first performance level; and
conveying, by the circuitry, control signals based on the mapping to an interconnect to connect the first functional block to the second functional block.

14. The method as recited in claim 11, wherein:
the first functional block is connected to an endpoint device that uses data generated by tasks requiring a performance level of the request;
each of the second functional block and the third functional block is an instantiated copy of a frontend circuit that processes rendered video data; and
the first functional block is a backend circuit that processes data generated by the frontend circuit.

15. A computing system comprising:
a configuration control circuit;
a processor comprising circuitry configured to send one or more tasks to the configuration control circuit;
wherein the configuration control circuit is configured to:
receive a request from the processor;
service the request using a first functional block and a second functional block, responsive to the request requiring a first performance level; and
service the request using the first functional block and a third functional block different from the second functional block, responsive to the request requiring a second performance level different from the first performance level.

16. The computing system as recited in claim 15, further comprising a plurality of chiplets, wherein the second functional block and the third functional block are located on different chiplets of the plurality of chiplets.

17. The computing system as recited in claim 16, wherein the configuration control circuit is further configured to determine a performance level of the request based on endpoint features specified in the request.

18. The computing system as recited in claim 16, wherein the configuration control circuit is further configured to determine a performance level of one or more functional blocks based on identifiers of the functional blocks.

19. The computing system as recited in claim 18, wherein one or more chiplets of the plurality of chiplets provide a different performance level than other chiplets of the plurality of chiplets.

20. The computing system as recited in claim 18, wherein:
the first functional block is connected to an endpoint device that uses data generated by tasks requiring a performance level of the request;
each of the second functional block and the third functional block is an instantiated copy of a frontend circuit that processes rendered video data; and
the first functional block is a backend circuit that processes data generated by the frontend circuit.
